(19) United States
(12) Patent Application Publication
(10) Pub. No.: US 2024/0318815 A1
(43) Pub. Date: Sep. 26, 2024

(54) METHOD OF DETERMINING A TUBE LEAKAGE IN A WATER-STEAM CIRCUIT OF A COMBUSTION BOILER SYSTEM, AND A COMBUSTION BOILER

(71) Applicant: SUMITOMO SHI FW ENERGIA OY, Espoo (FI)

(72) Inventor: Teri HILTUNEN, Leppävirta (FI)

(21) Appl. No.: 18/576,482

(22) PCT Filed: Sep. 9, 2021
(86) PCT No.: PCT/EP2021/074841

§ 371 Date: Jan. 4, 2024

(51) Int. Cl. F22B 37/42

(52) U.S. Cl. CPC F22B 37/421

(57) ABSTRACT

A method of determining a tube leakage in a water-steam circuit of a combustion boiler system. The method includes measuring a main steam flow (QMS,M) prevailing in the water-steam circuit of the system during operation, modelling the main steam flow (QMS,C) in the water-steam circuit during operation by utilizing process data in a numerical model of the system giving the main steam (QMS,C) flow of the system under substantially tube-leak-free conditions, comparing the measured water-steam flow with the modelled water-steam flow to obtain an error measure (DMS) for main steam flow included in an error measure set, monitoring the error measure set and number of occurrences in the error measure set during operation, and determining the presence of a water-steam circuit tube leakage when error measures (Δ_{MS}) exceed a pre-defined threshold, or a number of occurrences in the error measure set exceed a predetermined threshold during a predetermined time period.

### CROSS-REFERENCE TO PRIORITY APPLICATIONS

This application is a 35 U.S.C. § 371 National Stage patent application of International patent application PCT/EP2021/074841, filed on Sep. 9, 2021.

### FIELD OF THE INVENTION

The invention relates to detection and assessment of tube leakages in a water steam circuit of combustion boilers, in particular fluidized bed boilers, such as circulating fluidized bed (CFB) boilers or bubbling fluidized bed (BFB) boilers.

### TECHNICAL BACKGROUND

Combustion boilers, such as grate boilers and fluidized bed boilers are commonly utilized to generate steam that can be used for variety of purposes, such as for producing electricity and heat.

In a fluidized bed boiler, fuel and a hot bed of solid particulate bed material is introduced into a furnace and by introducing fluidizing gas from a bottom portion of the furnace to fluidize the bed material and the fuel. Burning of fuel takes place in the fluidized bed. In BFB combustion, fluidization gas is passed through the bed such that the gas forms bubbles in the bed. The fluidized bed can, in a BFB, be rather conveniently controlled by controlling the fluidization gas feed and the fuel feed.

In CFB combustion, fluidization gas is passed through the bed material. Most bed particles will be entrained in the fluidization gas and will be carried away with flue gas. The particles are separated from the flue gas in at least one particle separator and circulated, returning them back into the furnace. It is common to arrange a fluidized bed heat exchanger downstream of the particle separator(s) to recover heat from the particles before being returned into the furnace.

A boiler tube leakage causes water or steam to escape from the water steam circuit, where it generally has a pressure in the range of 100 to 300 bar, such that the escaped water or steam can enter a location of the boiler in an uncontrolled manner. A tube leakage can in a worst case causes a need for comprehensive boiler repair. Most of the tube leakage situations have much less severe consequences, at least if the leakage is detected reasonably fast.

A boiler tube leakage generally requires shutting down the combustion boiler, locating the leakage, and repairing or replacing of the tubes for which the leakage had taken place. From the viewpoint of a combustion boiler operator, this can be a costly procedure. Not only so because of the expenditure caused by locating the leakage and then repairing or replacing of the tubes, but shutting down the combustion boiler causes the boiler to stop producing steam (which could be utilized to produce electricity or heating), with the boiler operator generally losing a source of income during the shutdown. In view of the costs resulting and loss of steam production capability, it is important to avoid unnecessary shutdowns. The leakage detection should be performed reliably.

A CFB leakage detection system of the applicant is disclosed in Modern Power Systems (www.modernpowersystems.com) December 2018 article “Boiler Technology—SmartBoiler™: how the Internet of Things can improve boiler operating performance”. A boiler leakage detection module closely monitors furnace walls and other boiler heat exchange surfaces and, based on regression models using real process data and self-learning algorithms, predicts future problems so that maintenance could be planned in advance and restoration time be minimized.

### Objective of the Invention

An objective of the invention is to improve tube leakage detection in a water-steam circuit of combustion boilers.

This objective can be achieved with the method and a combustion boiler system defined by the claims.

### Advantages of the Invention

A method for determining a tube leakage in a water-steam circuit of a combustion boiler system comprises the steps of measuring the main steam flow Q_{MS,M} prevailing in the water-steam circuit of the combustion boiler system during operation, modelling main steam flow Q_{MS,C} in the water-steam circuit during operation by utilizing process data in a numerical model of the combustion boiler system giving the main steam Q_{MS,C} flow of the combustion boiler system under substantially tube-leak-free conditions, comparing the measured water-steam flow and modelled water-steam flow with each other to obtain an error measure ΔMS for main steam flow that is included in an error measure set, and monitoring the error measure set and characteristics of error measure set exceeding a predetermined threshold during a predetermined time period during operation to determine the presence of a water-steam circuit tube leakage.

With the method, it will be possible to improve tube leakage detection in a water-steam circuit of a combustion boiler. Even though the main steam flow may have large fluctuations between consecutive measurements, with a suitable numerical model of the combustion boiler system, the main steam flow can, under substantially tubeleak-free conditions, be computed numerically such rapidly that the error measure ΔMS will indicate with sufficient probability the presence of a tube leakage.

Further, suitably preparing the characteristics monitoring, it will be possible to select the predetermined threshold such that (i) sufficiently large (exceeding a pre-defined threshold, for example) error measures ΔMS will cause the determination of a water-steam circuit tube leakage faster than smaller error measures ΔMS, and (ii) also the smaller error measures ΔMS will cause the determination of a water-steam circuit tube leakage if they persist for a pre-defined time (or number of measurements). This selection of the characteristics monitoring, and, in particular, the selected “boosting factor” approach used in the monitoring of error measure set and characteristics of error measure set, developed by the present inventors, significantly contributes to the functioning of the method.

The “boosting factor” approach reflects the observation by the present inventors that tube leakages in the water-steam circuit of a combustion boiler system may develop gradually, i.e., begin as small leaks. If unnoticed, a small leak may become a large leak within some time. In view of the large fluctuations or variance in the main steam measurement, it has so far not been possible to reliably detect a small leak without using specific markers in the water-steam circuit. Thus, it has been prone that tube leakages have been so far reliably detected only after the leak has become severe enough, which, however, tends to increase the effort needed to repair the combustion boiler system. With the present invention, the tube leakage detection reliability may be improved, thus helping to avoid false alarms (leading to unnecessary shutdowns and costly off-time of the combustion boiler system), but still being able to detect tube leakages fast.

The main steam flow is preferably measured in the water-steam circuit between a final superheater and turbine.

The error measure ΔMS for main steam flow is preferably the difference (ΔMS=Q_{MS, MEASURED}−Q_{MS, COMPUTED}) between the measured steam flow (Q_{MS, MEASURED}) with the computed steam flow (Q_{MS, COMPUTED}).

Alternatively, the error measure ΔMS for main steam flow may be the ratio between the measured steam flow (Q_{MS, MEASURED}) and the computed steam flow (Q_{MS, COMPUTED}). These aspects may be combined such that the error measure ΔMS for main steam flow may be

a difference (ΔMS=Q_{MS, MEASURED}−Q_{MS, COMPUTED}) between the measured steam flow (Q_{MS, MEASURED}) with the computed steam flow (Q_{MS, COMPUTED}); and/or

a ratio between the measured steam flow (Q_{MS, MEASURED}) and the computed steam flow (Q_{MS, COMPUTED}).

The method may further comprise the steps of measuring at least one process parameter prevailing in at least one location of the fireside of the combustion boiler system, modelling at least one of corresponding process parameters during operation of the combustion boiler system by utilizing process data in a numerical model, giving the corresponding process parameter of the combustion boiler system under substantially leak-free conditions, comparing the at least one measured process parameters and said corresponding at least one modelled process parameters with each other to obtain an error measure for the at least one process parameters also included in the error measure set.

With this approach, the fireside measurements can be deployed to improve the accuracy in the method, and/or also to include detection of the combustion boiler system component in which the tube leakage is present. Most conveniently, the process parameters comprise or consist of at least one of temperature and/or pressure.

Error measure for the at least one process fireside parameter may be a difference between the measured process parameter and the modeled process parameter.

Alternatively, error measure for the at least one process fireside parameter may be a ratio between the measured process parameter and the modeled process parameter.

These may be combined, such that error measure for the at least one process fireside parameter may be a difference between the measured process parameter and the modeled process parameter and/or a ratio between the measured process parameter and the modeled process parameter.

According to an embodiment of the invention, the characteristics of error measure set may comprise a number of occurrences exceeding a predetermined threshold during a predetermined time period during operation.

Preferably, the feed water flow is measured before economizer.

The preferred embodiment of the invention is a circulating fluidized bed (CFB) boiler system, but the invention can be realized also, among other kinds of combustion boiler systems, specifically, also in a bubbling fluidized bed (BFB) boiler system.

In the case of a CFB boiler system, the process parameter measured in at least one location of the fireside preferably includes or consists of a pressure in a loop seal arranged downstream of a particle separator in return leg, or in other words return channel, which return leg is arranged for returning separated particles into a furnace.

In this situation, preferably, the method comprises monitoring a number of occurrences of error measure for main steam flow exceeds predetermined threshold, which, the number of occurrences in exceeding is included in the characteristics of error measure, and the method further comprises monitoring a number of occurrences of error measure for pressure in the loop seal exceeds predetermined threshold, which the number of occurrences in exceeding is included in the characteristics of error measure. A water-steam circuit leakage may then be determined to be in the loop seal (i) if the error measure for main steam flow and the number of occurrences of error measure for main steam flow exceed the predetermined threshold and further (ii) if an error measure related to pressure in the loop seal and the number of occurrences of pressure in the loop seal parameters in the loop seal exceed the predetermined threshold.

In the case of a CFB boiler system, the process parameter measured in at least one location of the fireside preferably includes or consists of a flue gas temperature at an exit of a particle separator.

In this situation, preferably, a leakage is determined to be in the particle separator (i) if the error measure for main steam flow and the number of occurrences of error measure for main steam flow both exceed, respectively, the predetermined threshold for corresponding error measures, and further (ii) if an error measure related to flue gas temperature at the exit of the particle separator and the number of occurrences of flue gas temperature at the exit of particle separator both exceed, respectively, a predetermined threshold for the flue gas temperature error measures.

In the case of a CFB boiler system, the process parameter measured in at least one location of the fireside preferably includes or consists of bed temperature in a fluidized bed heat exchanger that comprises reheater tubes (the reheater is located after the water-steam circuit) and/or superheater tubes. It has been particularly difficult to detect water-steam circuit tube leakages in both of these components based on the monitoring of the water-steam circuit since the output of both components will actually be led to the turbine (for reheater, the medium-pressure turbine and for superheater, the high-pressure turbine), which is after the water-steam circuit of the CFB boiler system.

In this situation, preferably, the process parameter includes or consists of bed temperature in a fluidized bed heat exchanger that comprises superheater tubes. Further, preferably, a tube leakage is determined at the fluidized bed heat exchanger if an error measure of bed temperature of the fluidized bed heat exchanger and the number of occurrences of error measure both exceed, respectively, a predetermined threshold, preferably not requiring the error measure for main steam flow to exceed the respective threshold since the reheater is located after the water-steam circuit.

Common for all aspects and embodiments of the method is that the characteristics of error measure may include or consist of the number of respective occurrences exceeding a predetermined threshold.

The combustion boiler comprises a local control system and/or is connected to a remote control system, the control system(s) configured to carry out the tube leakage determination method. The combustion boiler system further comprises a displaying means such as a display/monitor for displaying the boiler operator the presence of tube leakage detected using the method.

### BRIEF DESCRIPTION OF THE DRAWINGS

In the following, the method and the combustion boiler system are explained in more detail with reference to the exemplary embodiments disclosed in the appended drawings of which:

FIG. 1 illustrates a CFB boiler system;

FIG. 2 illustrates a BFB boiler system;

FIG. 3 illustrates a calibration method for the numerical model in a CFB boiler system;

FIG. 4 illustrates a possibility for training of the mathematical model and data usage;

FIG. 5 illustrates the calculation of tube leakage risk;

FIG. 6A to FIG. 6I show selected data of a test in which the method was applied on real CFB boiler system data to verify the functioning of the method.

The same reference numerals refer to same technical features in all FIG.

### DETAILED DESCRIPTION

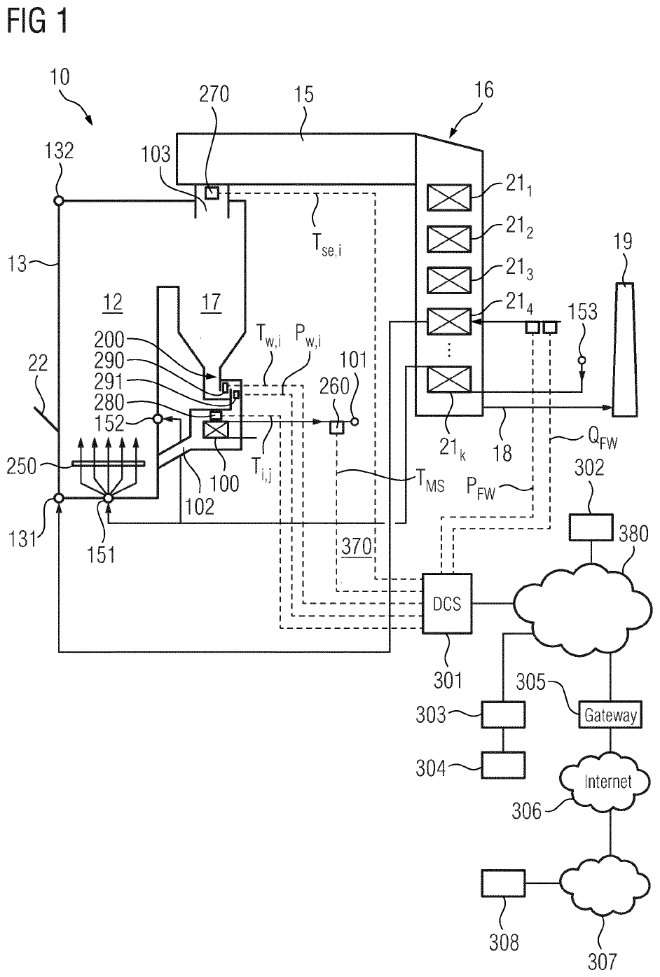

FIG. 1 shows a combustion boiler system 10 that is a CFB boiler and comprises a furnace 12 that has tube walls 13 (typically, comprising a front wall, rear wall, side walls) connected to a water-steam circuit of the combustion boiler system 10. FIG. 1 illustrates an OTU boiler case where water is fed from water tank 50 to evaporator (walls of furnace) and then guided via superheaters to a turbine (not shown in figures). A flue gas channel may be provided with economizer and/or superheaters.

Fluidization gas (such as, air and/or oxygen-containing gas) is fed from fluidization gas supply 153 to below the grate (the grate not shown in FIG. 1) via primary fluidization gas feed 151, usually such that the primary fluidization air enters the furnace through nozzles at the grid 250 (to fluidize the bed material and fuel), and secondary fluidization gas feed 152 (to feed oxygen containing gas such as air to control combustion). The effect is that the bed materials will be fluidized and also oxygen required for the combustion is provided into the furnace 12. Further, fuel is fed into the furnace 12 via the fuel feed 22.

The combustion can be adjusted by controlling the fuel feed 22 (such as, by reducing or increasing the fuel feed), and by controlling the fluidization gas feed (such as, by reducing or increasing amount of oxygen-containing ga (such as combustion air) supply into the furnace 12). Fuel can be fed together with additives, in particular, with such additives that act as alkali sorbents, such as CaCO₃ and/or clay, for example. In addition or alternatively, NOₓ reduction agents, such as ammonium or urea can be fed into the combustion zone of the furnace 12, or above the combustion zone of the furnace 12.

Bed material is also fed into the furnace, which bed material may comprise sand, limestone, and/or clay, that, in particular, may comprise kaolin. One effect of the bed and, generally, of the combustion, is that, in the water-steam circuit, water and steam are heated in the tube walls 13 and the water is converted to steam.

Bottom ash may fall to the bottom of the furnace 12 and be removed via an ash chute (omitted from FIG. 1 for the sake of clarity) and part of the ash, so-called fly ash, will be carried along with flue gas.

Combustion products, such as flue gas, unburnt fuel and bed material proceed from the furnace 12 to a particle separator 17 that may comprise a vortex finder 103. The particle separator 17 separates flue gases from solids. Especially, in larger combustion boilers 10, there may be more than one (two, three, . . . ) separators 17, preferably, arranged in parallel to each other.

Solids separated by the separator 17 pass through a loop seal 200 that preferably is located at the bottom of the separator 17. Then, the solids pass to fluidized bed heat exchanger (FBHE) 100 that is also a heat transfer surface (such as, but not limited, comprising tubes and/or heat transfer panels) so that the FBHE 100 collects heat from the solids to further heat the steam in the water-steam circuit.

The FBHE 100 may be fluidized and comprise heat transfer tubes or other kinds of heat transfer surfaces and be arranged as a reheater or as a superheater. From the FBHE outlet 101, steam is passed into a high-pressure turbine (if the FBHE 100 is superheater) or medium-pressure turbine (if the FBHE 100 is a reheater).

The solids may exit the FBHE 100 via return channel 102 into furnace 12. Especially, in larger combustion boilers 10, there may be more than one (two, three, . . . ) loop seals 160 and FBHE 100, and return channel 102, preferably, arranged in parallel to each other, such that for each separator 17, there will be respective loop seal 160, FBHE 100 and return channel 102. In practice, some of the FBHE 100 may be arranged as superheaters while some others may be arranged as reheaters.

The flue gases are passed from the separator 17 to crossover duct 15 and from there further to back pass 16 (that, preferably, may be a vertical pass) and from there via flue gas duct 18 to stack 19.

The back pass 16 comprises a number of heat transfer surfaces 21i(where i=1, 2, 3, . . . , k, where k is the number of heat transfer surfaces). In FIG. 1, of the heat transfer surfaces, heat transfer surfaces 21₁, 21₂, 21₃, 21₄ 21ₖ are illustrated. Heat transfer surface 21ₖ depicts an air preheater. Other heat transfer surfaces include an economizer, superheaters, and reheaters in flue gas channel (back pass 16). The actual number of different heat transfer surfaces in each of these components, for example, may be selected for each combustion boiler differently according to actual needs. And, there may be further components, as well, comprising a heat transfer surface 21.

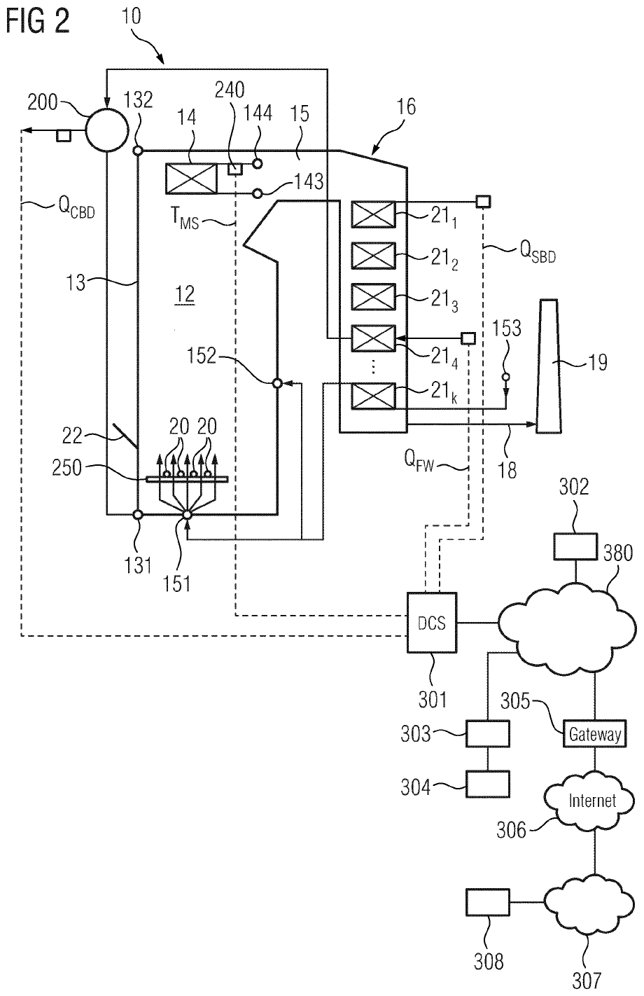

A combustion boiler system 10 is equipped with a plurality of sensors and computer units. Actually, one middle-size (100 to 150 MWth) combustion boiler system 10 may produce 100 million measurement results/day, which needs 25 GB of storage space. FIG. 1. and FIG. 2 illustrate some of the sensors and computer units. Examples of sensors are main steam flow sensor sensor 260 measuring the output steam temperature at the outlet 101 of the FBHE 100, temperature sensor 280 measuring bed temperature at the FBHE 100 chamber, temperature sensor 270 measuring the flue gas exit temperature at the separator 17, the temperature sensor 290 measuring the temperature in the loop seal 200, and/or the pressure sensor 291 measuring the pressure in the loop seal 200. The FBHE may be provided with a pressure sensor for measuring pressure at FBHE chamber. Specifically, FBHE 100 is a final superheater wherefrom steam is introduced in to a turbine via the FBHE outlet 101.

Process data may be collected from the sensors by distributed control system (DCS) 301. The data collection may most conveniently be arranged over a field bus 370, for example. DCS 301 may have a display/monitor 302 for displaying operational status information to the operator. An EDGE server 303 may process measurement data from the obtained from sensors, such as, filter and smooth it. There may be a local storage 304 for storing data.

The DCS 301, display/monitor 302, EDGE server 303, local storage 304 may be in combustion boiler network 380 (local storage 304 preferably directly connected to the EDGE server 303 ). The combustion boiler network 380 is preferably separate from the field bus 370 that is used to communicate measurement results from the sensors to the DCS 301 and/or the EDGE server 303. Between the DCS 301 and EDGE server 303 there may be an open platform communications server to make the systems better interoperable.

Combustion boiler network 380 may be in connection with the internet 306, preferably, via a gateway 305. In this situation, measurement results may be transferred from the combustion boiler network 380 to a cloud service, such as to process intelligence system 308 located in a computation cloud 207. The applicant currently operates a cloud service running an analysis platform. The cloud service may be operated on a virtualized server environment, such as on Microsoft® Azure® which is a virtualized, easily scalable environment for distributed computing and cloud storage for data. Other cloud computing services may be suitable for running the analysis platform too. Further, instead of a cloud computing service, or, in addition thereto, a local or remote server can be used for running the analysis platform.

FIG. 2 illustrates a combustion boiler system 10 that is a BFB boiler. A BFB boiler differs from a CFB boiler in that the fluidized bed is not a circulating bed but a bubbling bed. Thus, there is no need for the separator 17, loop seal 160, FBHE 100, and return channel 102.

In drum boilers, water generally can be fed to economizer and, from the economizer, via a steam drum to evaporative heat transfer surfaces such as the furnace wall of the boiler and then guided via steam drum to superheaters and then to a turbine.

There is normally at least one superheater 14 located in the furnace 12, preferably, on the upper part of the furnace 12. Superheater 14 inlet 143 may be from a steam drum and the outlet 144 is to a high pressure turbine. Temperature sensor 240 measures the temperature at the superheater outlet 144. Specifically, the main steam flow sensor 240 measures the main steam flow at the superheater outlet 144, which superheater is a final superheater wherefrom steam will be guided to a turbine.

The method for determining a tube leakage in a water-steam circuit of a combustion boiler system 10 comprises the steps of measuring the main steam flow Q_{MS,M} prevailing in the water-steam circuit of the combustion boiler system 10 during operation, modelling main steam flow Q_{MS,C} in the water-steam circuit during operation by utilizing process data in a numerical model of the combustion boiler system 10 giving the main steam Q_{MS,C} flow of the combustion boiler system 10 under substantially tube-leak-free conditions, comparing the measured water-steam flow and modelled water-steam flow with each other to obtain an error measure D_{MS} for main steam flow that is included in an error measure set, and monitoring the error measure set and characteristics of error measure set exceeding a predetermined threshold during a predetermined time period during operation to determining the presence of a water-steam circuit tube leakage.

The method may further comprise the steps of measuring at least one process parameter prevailing in at least one location of the fireside of the combustion boiler system 10, modelling at least one of corresponding process parameters during operation of the combustion boiler system 10 by utilizing process data in a numerical model, giving the corresponding process parameter of the combustion boiler system 10 under substantially leak-free conditions, and comparing the at least one measured process parameter and the corresponding at least one modelled process parameter with each other to obtain an error measure for the at least one process parameters also included in the error measure set.

The process parameter may comprise or consist of at least one of temperature and/or pressure.

Loop seal 290: The process parameter may include or consist of a pressure in a loop seal 290 arranged downstream a particle separator 17 in a return leg, which return leg is arranged for returning separated particles into a furnace 12. Then, the method preferably comprises monitoring a number of occurrences of error measure for main steam flow exceeds predetermined threshold. The number of occurrences exceeding is included in the characteristics of error measure. The method further comprises monitoring a number of occurrences of error measure for pressure in the loop seal that exceeds a predetermined threshold, which number of occurrences exceeding is included in the characteristics of error measure. A water-steam circuit leakage is determined to be in the loop seal if the error measure for main steam flow and the number of occurrences of error measure for main steam flow exceed the predetermined threshold and, further, if an error measure related to pressure in the loop seal and the number of occurrences of pressure in the loop seal parameters in the loop seal exceed the predetermined threshold.

Separator 17: The process parameter may include or consist of a flue gas temperature at an exit of a particle separator. Then, preferably, a leakage is determined to be in the particle separator if the error measure for main steam flow and the number of occurrences of error measure for main steam flow both exceed, respectively, the predetermined threshold for corresponding error measures and, further, if an error measure related to flue gas temperature at the exit of the particle separator and the number of occurrences of flue gas temperature at the exit of particle separator both exceed, respectively, a predetermined threshold for the flue gas temperature error measures.

FBHE 100 (reheater): The process parameter may include or consist of bed temperature in a fluidized bed heat exchanger that comprises reheater tubes, the reheater located after the water-steam circuit.

FBHE 100 (superheater): The process parameter may include or consist of bed temperature in FBHE 100 that comprises superheater tubes.

Superheater 14: The process parameter may include or consist of bed temperature in a superheater 14 of a BFB boiler system that is a fluidized bed heat exchanger comprising superheater tubes.

A tube leakage may be determined at the fluidized bed heat exchanger 100 comprising a reheater if an error measure of bed temperature of the fluidized bed heat exchanger and the number of occurrences of error measure both exceed, respectively, a predetermined threshold, preferably, not requiring the error measure for main steam flow to exceed the respective threshold since the reheater is located after the water-steam circuit.

Common for all embodiments is that the characteristics of error measure may include or consist of the number of respective occurrences exceeding a predetermined threshold.

Common for all embodiments is that the exceeding is tested within the evaluation time window. This may be s suitably selected time interval, such as, for the last sixty minutes.

As explained above, the combustion boiler system 10 comprises a local control system 301, 303 and/or is connected to a remote control system 308. The control system(s) is/are configured to carry out the leakage determination method. The combustion boiler system 10 comprises a displaying means such as a display/monitor 302 for displaying the boiler operator the presence of tube leakage detected using the method.

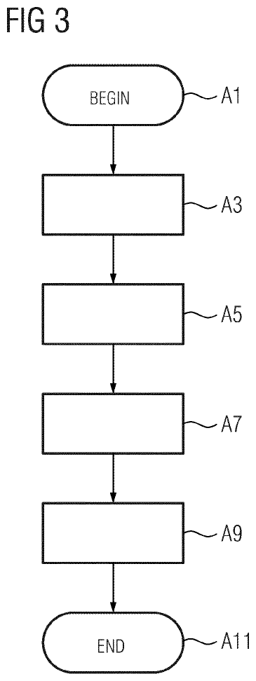

FIG. 3 illustrates an example of the model building or calibration process.

After initiation (step A1), in step A3, the numerical model for water/steam balance in the combustion boiler system 10 is constructed, such as by regression modelling. Depending on the type of the combustion boiler system 10, the model may be different, such as:

Equation for water/steam balance, drum boiler:

$${Q}_{ms , c} = {a}_{0} + {a}_{1} {Q}_{fw} + {a}_{2} Dt ( {Q}_{fw} ) + {a}_{3} {Q}_{cbd} + {a}_{4} {Q}_{sbd} + {a}_{5} Dt ( DL )$$

### Where:

Q_{ms,c}=modelled main steam flow

Q_{fw}=feed water flow may be measured before economizer

Dt(Q_{fw})=Dt(feed water flow)is a time derivative of feed water flow (how feed water flow changes in certain time)

Q_{cbd}=continuous blow down flow from steam is water discharged from the drum

Q_{sbd}=soot blow steam flow may be steam from superheater path before final superheater

Dt(DL)=Dt(drum level)is a time derivative of drum level (how drum level changes in certain time)

a₀, a₁. . . a₅=Calibration coefficients determined by linear regression method.

Alternatively, modeled main steam flow may be obtained using an artificial intelligence tools and/or neural network.
Equation for water/steam balance OTU boiler:

$${Q}_{m s , c} = {a}_{0} + {a}_{1} {Q}_{fw} + {a}_{2} D T ( {Q}_{fw} ) + {a}_{3} {P}_{fw} + {a}_{4} D t ( {P}_{f w} )$$

### Where:

Q_{ms,c}=modelled main steam flow

Q_{fw}=feed water flow

Dt(Q_{fw})=Dt(feed water flow)

Pfw =feed water pressure

Dt(Pfw) =Dt(feed water pressure)

a₀, a₁, . . . , a₄=calibration coefficients determined by linear regression method.

Alternatively, modeled main steam flow may be obtained using an artificial intelligence tools and/or neural network.

In step A5, for each FBHE 100ᵢ, a numerical model for the temperature calculation of the FBHEᵢ is constructed, such as by regression modelling:

Equation for FBHEᵢ bed temperature calculation

$${T}_{i , j , c} = {b}_{0} + {b}_{1} {T}_{w , i} + {b}_{2} {T}_{se , i} + {b}_{3} {Q}_{ms , m} + {b}_{4} Dt ( {Q}_{ms , m} )$$

### Where:

Tᵢⱼ=modelled bed temperatures of FBHE 100;

(number of temperature points is N so that, j=1, . . . , N)

T_{w,i}=loop seal 200; temperature

T_{se,i}=flue gas exit temperature of separator 17ᵢ

Q_{ms,m}=main steam flow

Dt(Q_{ms,m})=Dt(main steam flow)

b₀, b₁ . . . b₄=coefficients determined by linear regression method.

Alternatively, modeled bed temperature may be obtained using an artificial intelligence tools and/or neural network.

In step A7, for each separator 17ᵢ, a numerical model for the temperature calculation of the separator 17ᵢ is constructed, such as by regression modelling:

### Equation for Separatorᵢ Temperature Calculation

$${T}_{separator exit , i , c} = {c}_{0} + {c}_{1} {T}_{inlet , i} + {c}_{2} {T}_{msei}$$

where:

T_{separator exit,i.c}=modelled separator 17ᵢ flue gas exit temperature

Tₘₛₑᵢ=mean of other separator 17ⱼ (computed for all other separators 17ⱼ, except separatorᵢ, i.e. j¹i)

T_{separator, inlet, i}=separator 17ᵢ inlet temperature
c₀, c₁. . . c₂=coefficients determined by linear regression method.
   Alternatively, modeled separator flue gas exit temperature may be obtained using an artificial intelligence tools and/or neural network.

In step A9, for each loop seal 200ᵢ, a numerical model for the pressure at the loop seal 200ᵢ is constructed, such as by regression modelling:

Equation for loop seal 200ᵢ pressure calculation:

$${P}_{w s , i} = {d}_{0} + {d}_{1} {P}_{mwsi}$$

where:

P_{wsi}=Modelled loop sealᵢ pressure
P_{mwsj}=mean of other loop seal pressure (computed for all other loop seals 200ⱼ, except loop seal 200ᵢ, i.e. j¹i)
d₀, d₁=Factor determined by linear regression method.
   Alternatively, modeled bed loop seal pressure may be obtained using an artificial intelligence tools and/or neural network.

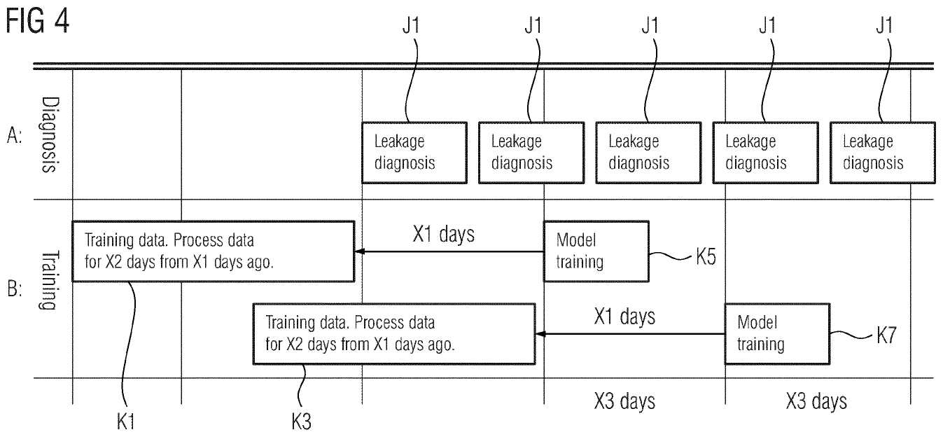

FIG. 4 illustrates the operation of the leakage detection system: diagnosis (A) and training (B) are separated:

In the diagnosis block (A), leakage diagnosis method J1 is preferably executed at predefined intervals or periodically, such as, every minute.

In the training block (B), there are at least two sets of training data. The training data set K1 comprises process data for X2 days from X1 days ago. Training data set comprises process data for X2 days from X1 days ago. But the starting and/or ending time for the training data sets K1, K3 are different (the difference denoted as X3 days). The training data sets K1, K3 may partially overlap or they may be so separated that they do not overlap.

The model training (cf. FIG. 3) for data set K1 may be invoked in step K5 at predefined intervals or periodically, such as, every X1 days. Similarly, model training (cf. FIG. 3) for data set K3 may be invoked in step K7, after the predefined interval (X3 days has passed).

The purpose of this practice is that, should there be a tube leakage in the water-steam circuit of the combustion boiler system 10, the tube leakage would corrupt the calibration data. Since some tube leakages develop slowly, this is believed to improve the reliability of the detection algorithm.

Examples of the use of models:

Model output is modelled values compared to expected values like:
Water/steam balance:

$$DMS = {Q}_{m s}^{′} - {Q}_{m s}$$

Q′ₘₛ=modelled main steam flow
Qₘₛ=measured main steam flow
DMS<DMSₗᵢₘᵢₜ in normal process state
DMSₗᵢₘᵢₜ=process/model/boiler dependent value.
   Separator 17ᵢ (where i=1, 2, . . . N, where N is the number of separators 17ᵢ in a combustion boiler system 10):

$$D s {e}_{i} = {T}_{s e , i}^{′} - {T}_{s e , i}$$

T′_{se,i}=Modelled separator 17ᵢ flue gas exit temperature
T_{se,i}=Measured separator 17ᵢ flue gas exit temperature
Dseᵢ<Dseₗᵢₘᵢₜ in normal process state for separators
Dseₗᵢₘᵢₜ=process/model/boiler dependent value.

### FBHE 100:

$${DT}_{i 1 … n} = {T}_{i 1 … n}^{′} - {T}_{i 1 … n}$$

T′_{i1 . . . n}=Modelled bed temperatures 1. . . n of FBHE 100ᵢ
Tᵢ₁. . . n=Measured bed temperatures 1. . . n of FBHE 100ᵢ
DT_{i1 . . .n}<DTₗᵢₘᵢₜ in normal process state for an FBHE
DTₗᵢₘᵢₜ=process/model/boiler dependent value.

Loop seal 200; (where i=1, 2, . . . . N, where N is the number of loop seals 200ᵢ in a combustion boiler system 10):

$$D {p}_{i} = {p}_{ws , i}^{′} - {p}_{w s , i}$$

p′_{ws,i}=modelled loop seal 200ᵢ pressure
P_{se,i}=measured loop seal 200ᵢ pressure
Dpᵢ<Dpₗᵢₘᵢₜ in normal process state for separators
Dpₗᵢₘᵢₜ=process/model/boiler dependent value.

### Superheater 14:

$$D {T}_{s h} = {T}_{S H}^{′} - {T}_{S H}$$

T′_{SH}=Modelled temperature of superheater 14
T_{SH}=Measured temperature of superheater 14
DT_{SH}<DT_{SH,limit} in normal process state for superheater 14
DT_{SH,limit}=process/model/boiler dependent value.

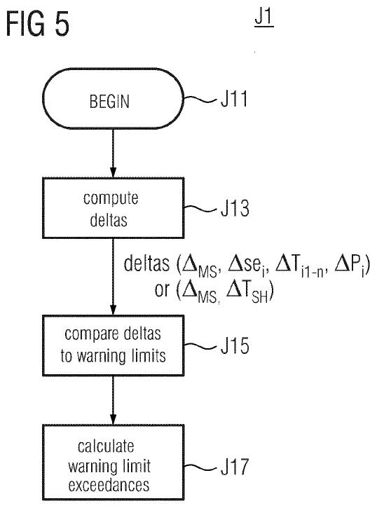

FIG. 5 illustrates the leakage diagnosis step (J1 in FIG. 4), in more particular, the calculation of tube leakage risk.

In step J13, the deltas are computed.

Initially, in CFB boiler system DMS, and, optionally, Dseᵢ and/or DT_{i1 . . . n} and/or Dpᵢ (and, respectively, in BFB boiler system DMS and, optionally, also DTₛₕ) may calculated for a predefined time interval, such as for last 60 minutes.

In the next step J15, the deltas are compared to the respective warning limits. A warning limit was set for each model as a constant and, when a delta is below the respective warning limit, process is on normal state. Then, diagnosis calculates in step J17 warning limit exceedances. In case of multi-model like FBHE 100ᵢ, a component is set as abnormal, if it exceeds the respective process/model/boiler dependent value, such as when DT_{i1 . . . n}>x Tube leakage risk level may be calculated using equations (internal value):

If nₑ * BF > tᵤ:
R = 100 + (nₑ * BF − tᵤ) / tᵣ * 100
else:
R_{C} = (nₑ * BF − t₁) / (tᵤ − t₁) * 100

### Where:

R_{C}=Leakage risk level of component (location) or water/steam balance
nₑ=Number of exceedances in reference period
tᵣ=Length of reference period (minutes)
t₁=Lower limit
tᵤ=Upper limit
BF=Boost factor

$$B F = 1 + ( {E}_{s} / ( WL * N ) - 1 ) * B .$$

### Where:

BF=Boosting factor
B=Boosting slope
WL=Warning limit for err
N=number of exceedances
Eₛ=sum(err), when err>Warning limit.
   Leakage index may be calculated using equations:

$${I}_{c} = {R}_{c} , if {R}_{c} < 100 ; {I}_{c} = 100 , if {R}_{c} > 100.$$

### Where:

I_{c}=Component leakage index (location) or water/steam balance index
R_{C}=Leakage risk level component (location) or water/steam balance.

If the leakage index is greater or equal 50 but below 100, a “yellow” warning is issued for location or water/steam balance.

If the leakage index is greater than 100, “red” warning for location or water/steam balance.

Overall leakage index:

if I_{cm} < 50:
I = R_{ws}/2
if I_{cm} >= 50:
I= R_{ws}/2 + I_{cm} / 2.

### Where:

I=overall leakage index

R_{ws}=Leakage risk level of water/steam balance

I_{cm}=Maximum component leakage index.

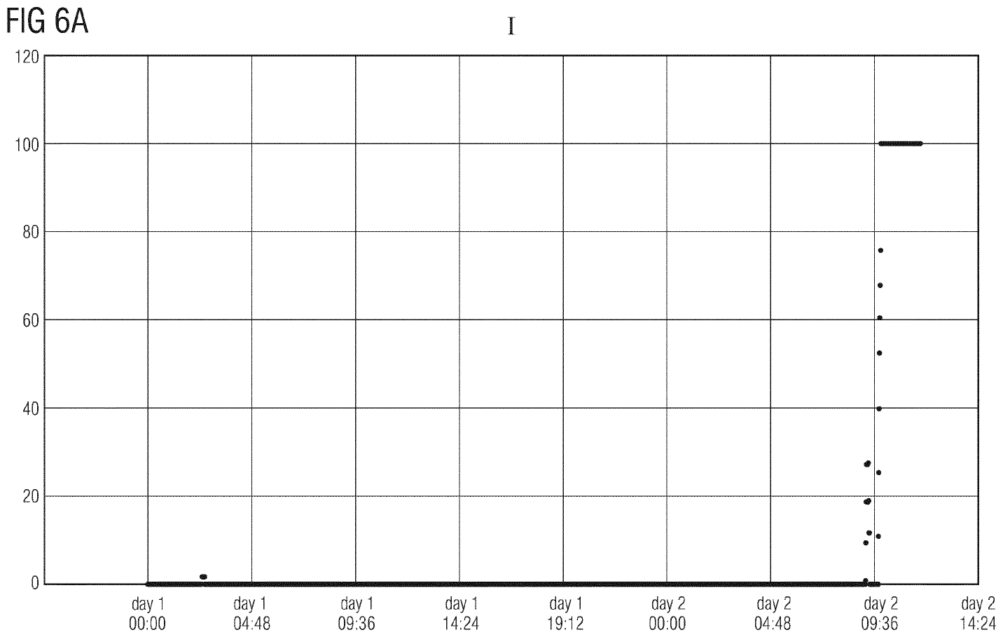

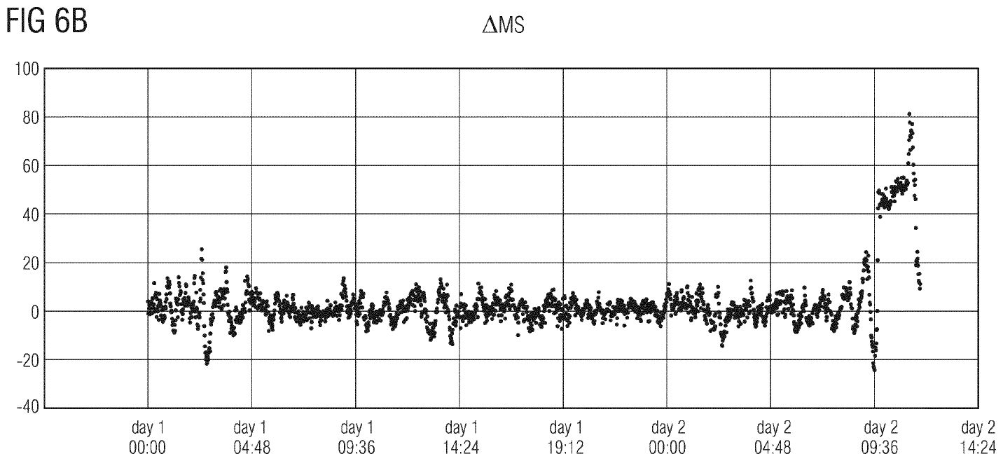

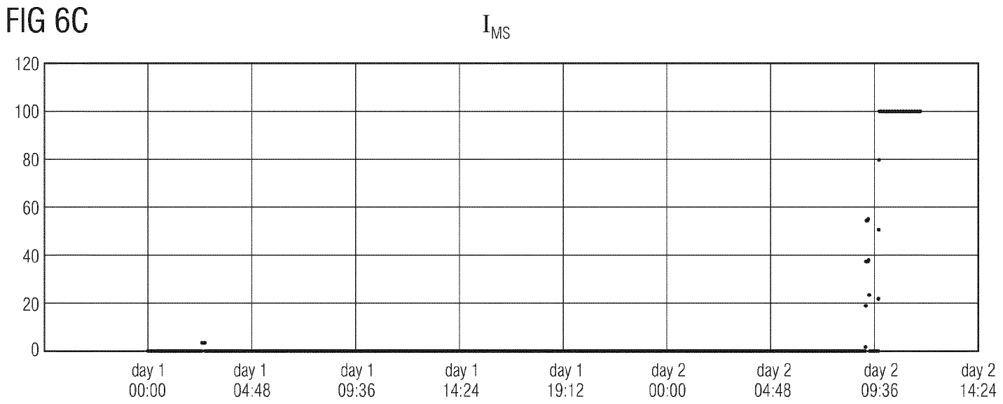

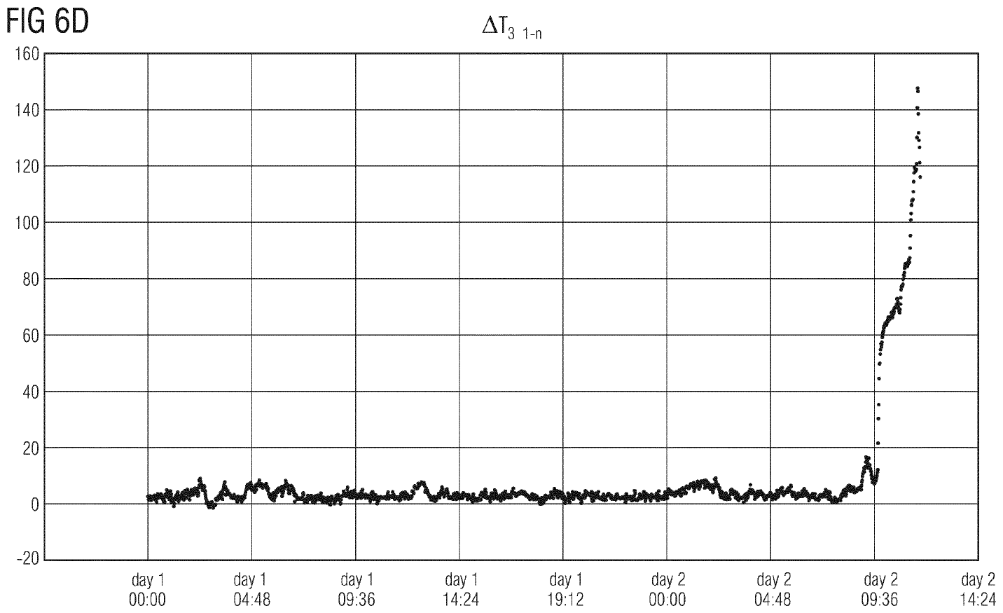

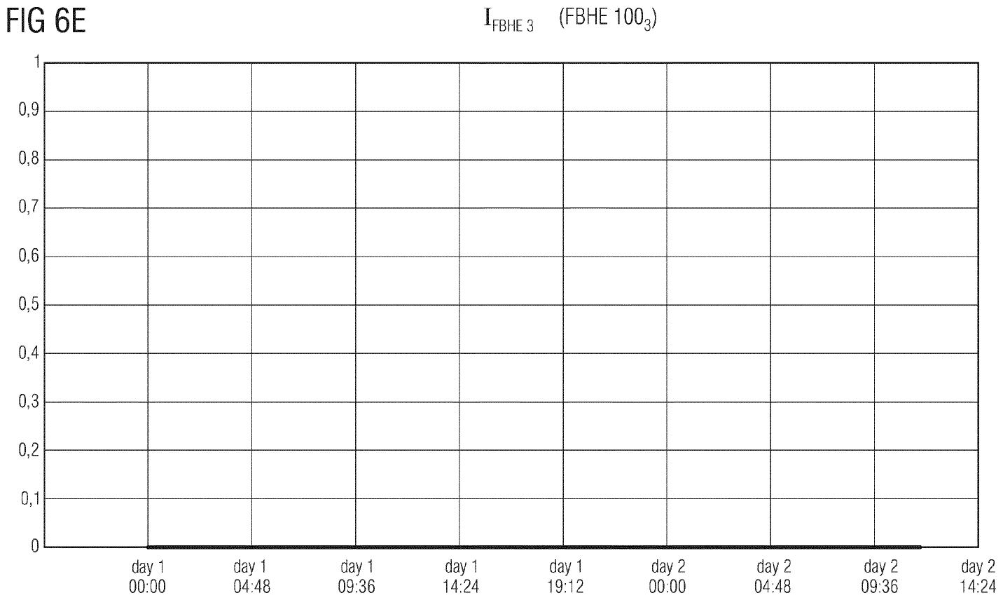

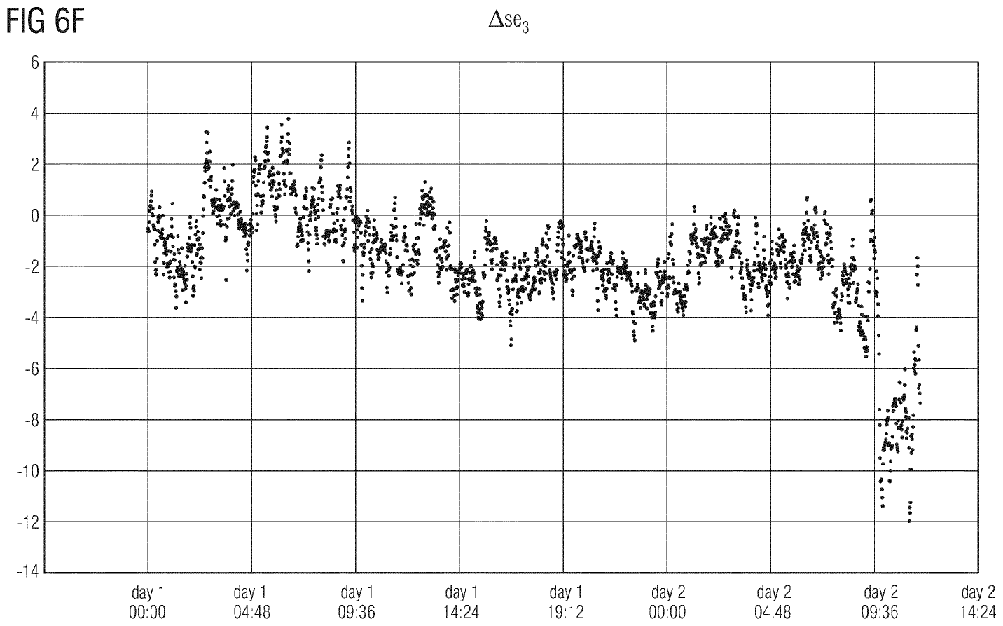

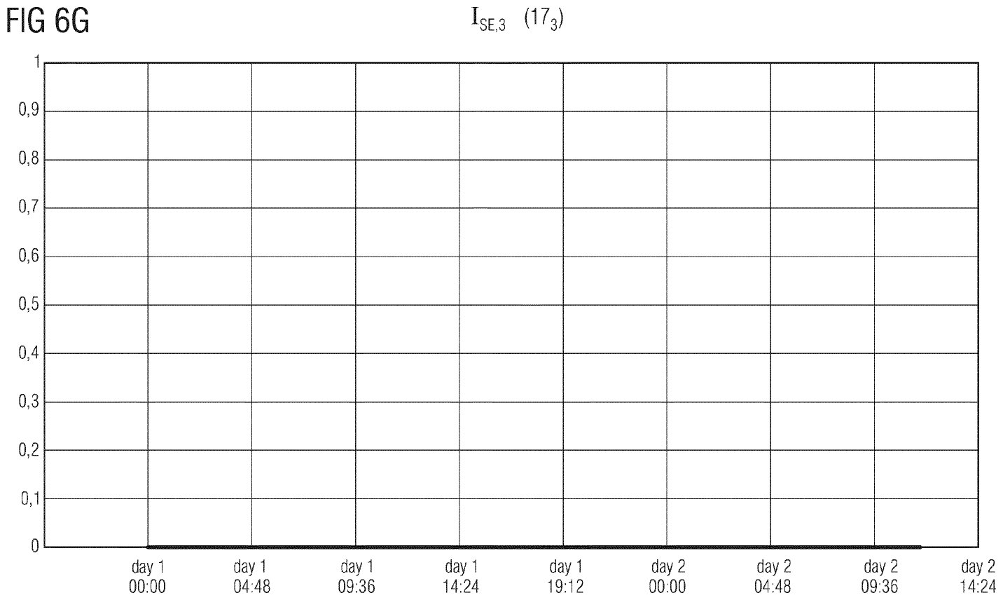

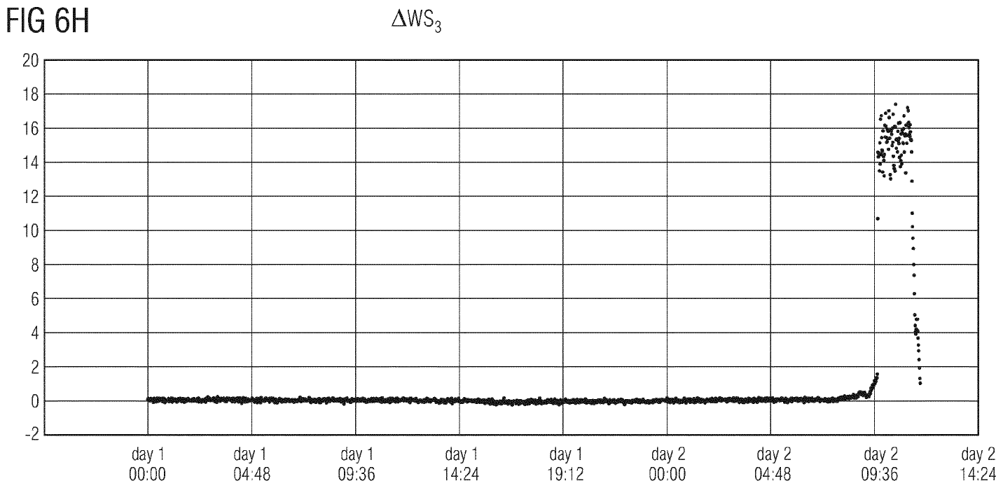

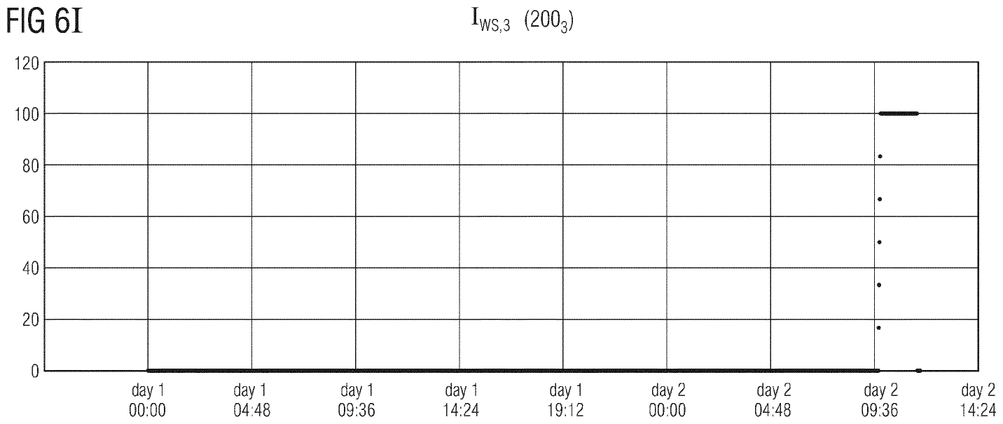

The present inventors have validated the functioning of the method on real data collected from a CFB combustion boiler system that was stored. The data is disclosed in FIG. 6A to FIG. 6I and shows (as could be understood to simulate a DCS 301, EDGE system, possibly with participation of a remote process intelligence system 308, and displayed on display/monitor 302 to the boiler operator) in an exemplary fashion how the method can be used to indicate the boiler operator a presence of a tube leakage in water-steam circuit of a combustion boiler system.

FIG. 6A shows the so computed overall leakage index I, computed as explained above, for a test period. As it can be seen, the index reaches 100 at rightmost time period column. There is a boiler leak present. In the actual situation where the process data is collected from the boiler was shut down.

FIG. 6B shows the delta in water/steam balance i.e. DMS computed of the same combustion boiler system 10 process data. The rather large fluctuations can be seen. There is a significant increase on at the rightmost time period column. FIG. 6C shows the leakage index I_{MS} computed only for water/steam balance.

FIG. 6D shows the delta for FBHE 100₃ i.e. DT_{3 1-n} computed of the same combustion boiler system 10 process data. The increase of the delta is rather slow. FIG. 6E shows the leakage index I_{FBHE 3} i.e. leakage index computed only for component FBHE 100₃.

FIG. 6F shows the delta for separator 17₃ i.e. Dse₃ computed of the same combustion boiler system 10 process data. FIG. 6G shows the leakage index I_{SE,3} i.e. leakage index computed only for component separator 17₃.

FIG. 6H shows the delta for loop seal 200₃ i.e. Dws₃ computed of the same combustion boiler system 10 process data. FIG. 6I shows the leakage index I_{WS,3} i.e. leakage index computed only for component loop seal 200₃.

From the overall leakage index I, the presence of a tube leakage in the water-steam circuit of combustion boiler system 10 can be detected reliable and possibly also sooner than in the previous realizations of the combustion boiler systems of the present applicant.

From the component-specific leakage indexes that are preferably computed for all leakage-prone components of the combustion boiler system 10 (in this example, leakage indexes for each FBHE 100ᵢ, for each separator 17ᵢ, and for each loop seal 200ᵢ), the location in which component the tube leakage is present can be detected reliably.

In other words, in the leakage detection method according to the first aspect of the present invention, a risk level is computed using a time series of measures between model-based quantities estimated for the actual bed situation using determined fluidized bed combustion boiler operating parameters and the respective quantities computed from measurements, such that measures account to the risk level in an over-proportional manner respective to their magnitude. The risk level may be indicated to the boiler operator. If the risk level exceeds a preset limit, the exceeding is indicated to the boiler operator, the boiler operator is alarmed, and/or the boiler shutdown is automatically suggested or initiated.

In the leakage detection method according to the second aspect of the present invention, a risk level is computed using a time series of measures between model-based quantities estimated for the actual bed situation using determined fluidized bed combustion boiler operating parameters and the respective quantities computed from measurements, such that measures are evaluated in at least two overlapping time windows having different lengths, wherein the narrower time window requires in proportion a higher number of measures exceeding a threshold value than the broader time window. The risk level may be indicated to the boiler operator. If the risk level exceeds a preset limit, the exceeding is indicated to the boiler operator, the boiler operator is alarmed, and/or the boiler shutdown is automatically suggested or initiated.

In the leakage detection method according to the third aspect of the present invention, a risk level is computed using a time series of measures between model-based quantities estimated for the actual bed situation using determined fluidized bed combustion boiler operating parameters and the respective quantities computed from measurements, such that the model-based quantities are estimated using calibrated values, and wherein the calibrated values are obtained by analyzing as training data historical data that from further in the past than the time series used in risk level computation. The risk level may be indicated to the boiler operator. If the risk level exceeds a preset limit, the exceeding is indicated to the boiler operator, the boiler operator is alarmed, and/or the boiler shutdown is automatically suggested or initiated.

The model-based quantities estimated for the actual bed situation using determined fluidized bed combustion boiler operating parameters and the respective quantities computed from measurements preferably include one or more of the following: water-steam balance, flue gas exit temperature, bed temperature, pressure, such that, advantageously, water-steam balance is used.

The risk level is preferably computed as a weighted sum of any different measures, optionally requiring for each measure the exceeding of a specific threshold value for it to be included in the computation. The risk level may further be computed so that when risk level exceeds 100% it is displayed only as 100%.

The differences between model-based quantities and the respective quantities computed from measurements may be rather large. These result from the fact that combustion conditions are under continuous change, and that there are certain fluctuations taking place all time in a combustion boiler. For a combustion boiler producing superheated steam in the rate of 400 kg/s, the steam flow may in practice fluctuate 5 to 10 kg/s up and down.

The finding behind the first aspect of the invention is that, while given the rather large fluctuations in the model-based quantities and the respective quantities computed from measurement certain make with a high probability smaller measures very frequent in the time series analysis, it is not very probable that larger measures would be present a number of times in the time series analysis without a good cause. Thus, a larger tube leakage in a combustion boiler can be detected considerably faster than in the background art (i.e., in Modern Power Systems December 2018 article), if the number of threshold values that are exceeded in a time window measures accounts to the risk level proportionally to sum of measures magnitude over-proportional manner respective to exceeding a threshold value to their magnitude. As an example, we refer to the results in the Modern Power Systems article in I11. 6 on p. 38. The applicant's former method was able to detect leakage in a furnace wall after about thirty minutes (second arrow from the left) from the start of the leakage (first arrow from the left). With the present method, the inventors have been able to reliably detect the same leakage in about two to four minutes, based on the same data.

The finding behind the second aspect of the invention is that, while given the rather large fluctuations in the model-based quantities and the respective quantities computed from measurement certain make with a high probability smaller measures very frequent in the time series analysis, it is not very probable that smaller measures would be present for a longer period of time without a good cause. Thus, a smaller tube leakage in a combustion boiler can be detected considerably more reliably than in the background art (i.e., in Modern Power Systems December 2018 article), if the measures are evaluated in at least two overlapping time windows having different lengths, such that the narrower time window will require in proportion to the time window length, a higher number of small measures exceeding a threshold value than the broader time window. With the present method, the inventors have been able to more frequently rule out suspected tube leaks as non-leaks also in situations that would, with the background art method, have led to a false leakage alarm.

The finding behind the third aspect is that the rather large fluctuations in the model-based quantities and the respective quantities computed from measurement may have some time shifting characteristics in the time series analysis. If there is time shifting, the computation of the estimates with the numerical model gives inaccurate results that may not be reliable any more. In this situation, since the model-based quantities are estimated using calibrated a mathematical model using coefficient values obtained using numerical fitting, the effect of the time shifting characteristics can be suppressed or even ruled out if the calibrated values are obtained by analyzing as numerical fitting is repeated on training data historical data that from further in the past than the time series used in the present risk level computation. Preferably, the historical data is from at least a few days ago, even better from a week or even two weeks ago. With this method, slowly developing tube leaks can be detected more reliably than with the method in the background art (i.e., in Modern Power Systems December 2018 article).

In the tube leakage detection method according to the fourth aspect of the present invention, a risk level is computed using a time series of measures between model-based quantities estimated for the actual bed situation using determined fluidized bed combustion boiler operating parameters and the respective quantities computed from measurements, including at least one, but preferably all, of the following, at least one separator, at least one solids return chamber heat exchanger, and at least one loop seal. The risk level may be indicated to the boiler operator. If the risk level exceeds a preset limit, the exceeding is indicated to the boiler operator, the boiler operator is alarmed, and/or the boiler shutdown is automatically suggested or initiated.

The finding behind the fourth aspect is that in fluidized bed boilers, a tube leakage can generally cause an effect comparable with sandblasting, where abrasive bed material is pressed by high pressure steam or water against a boiler structure, such as another tube. Thus, CFB boiler leakage detection that is carried out for at least one separator, at least one solids return chamber heat exchanger, and/or at least one loop seal can help to reduce damage in these parts of the boiler.

Even though a tube leakage does not necessarily have very bad consequences in the furnace if the furnace wall water tube is leaking, the situation will be drastically different in certain CFB boiler structures (separator, solids return chamber heat exchanger, loop seal) where heat exchanger tubes are relatively close to each other. In the solids return chamber heat exchanger, for example, the separation of neighboring heat exchanger tubes may be only 10 cm, a tube leakage in such a component with further a high bed material density may cause a rapid worsening of the leakage by the increasing abrasive effect of bed material due to the leakage. In the lower part of a CFB furnace, for example, the bed material density may be in the range of some dozens kg/m³, while, in the solids return chamber heat exchanger, the bed material density may be in the range of 1000 to 1500 kg/m³. Further, a leak in furnace tube wall does not generally damage neighboring tubes since the neighboring tubes will not be in the direction of the bed material blasting caused by the leakage.

It is obvious to the skilled person that, along with the technical progress, the basic idea of the invention can be implemented in many ways. The invention and its embodiments are thus not limited to the examples and samples described above, but they may vary within the contents of patent claims and their legal equivalents.

In the claims that follow and in the preceding description of the invention, except where the context requires otherwise due to express language or necessary implication, the word “comprise” or variations such as “comprises” or “comprising” is used in an inclusive sense, i.e., to specify the presence of the stated feature, but not to preclude the presence or addition of further features in various embodiments of the invention.

1-14. (canceled)

15. A method of determining a tube leakage in a water-steam circuit of a combustion boiler system, the method comprising the steps of:
measuring a main steam flow (Q_{MS,M}) prevailing in the water-steam circuit of the combustion boiler system during operation;
modelling the main steam flow (Q_{MS,C}) in the water-steam circuit during operation by utilizing process data in a numerical model of the combustion boiler system giving the main steam (Q_{MS,C}) flow of the combustion boiler system under substantially tube-leak-free conditions;
comparing the measured water-steam flow and the modelled water-steam flow with each other to obtain an error measure (D_{MS}) for main steam flow that is included in an error measure set;
monitoring the error measure set and a number of occurrences in the error measure set during operation; and
determining the presence of a water-steam circuit tube leakage in the case error measures (Δ_{MS}) exceed a pre-defined threshold, or a number of occurrences in the error measure set exceed a predetermined threshold during a predetermined time period.

16. The method according to claim 15, further comprising the steps of:
measuring at least one process parameter prevailing in at least one location of the fireside of the combustion boiler system;
modelling at least one of corresponding process parameters during operation of the combustion boiler system by utilizing process data in a numerical model, giving the corresponding process parameter of the combustion boiler system under substantially leak-free conditions; and
comparing the at least one measured process parameter and the corresponding at least one modelled process parameter with each other to obtain an error measure for the at least one process parameters also included in the error measure set.

17. The method according to claim 16, wherein the process parameters comprise at least one of temperature or pressure.

18. The method according to claim 16, wherein the combustion boiler system is a circulating fluidized bed boiler system.

19. The method according to claim 16, wherein the process parameters include a pressure in a loop seal arranged downstream of a particle separator in a return leg, which return leg is arranged for returning separated particles into a furnace.

20. The method according to claim 19, further comprising:
monitoring a number of occurrences of an error measure for main steam flow exceeding a predetermined threshold, wherein a number of occurrences in the exceeding is included in the characteristics of error measure; and
monitoring a number of occurrences of error measure for pressure (p_{w,i}) in the loop seal exceeding a predetermined threshold, which number of occurrences in exceeding is included in the characteristics of error measure,
wherein a water-steam circuit leakage is determined to be in the loop seal if the error measure for main steam flow and the number of occurrences of error measure for main steam flow exceed the predetermined threshold, and, further, if an error measure related to pressure in the loop seal and the number of occurrences of pressure in the loop seal parameters in the loop seal exceed the predetermined threshold.

21. The method according to claim 16, wherein the process parameters include a flue gas temperature (T_{se,i}) at an exit of a particle separator.

22. The method according to claim 21, wherein a leakage is determined to be in the particle separator if the error measure for main steam flow and the number of occurrences of error measure for main steam flow both exceed, respectively, the predetermined threshold for corresponding error measures, and, further, if an error measure related to flue gas temperature at the exit of the particle separator and the number of occurrences of flue gas temperature at the exit of particle separator both exceed, respectively, a predetermined threshold for the flue gas temperature error measures.

23. The method according to claim 16, wherein the process parameters include bed temperature in a fluidized bed heat exchanger that comprises reheater tubes, the reheater tubes being located after the water-steam circuit.

24. The method according to claim 16, wherein the process parameters include bed temperature in a fluidized bed heat exchanger that comprises superheater tubes.

25. The method according to claim 24, wherein a tube leakage is determined at the fluidized bed heat exchanger if an error measure of bed temperature of the fluidized bed heat exchanger and the number of occurrences of error measure both exceed, respectively, a predetermined threshold.

26. The method according to claim 15, wherein the characteristics of error measure include the number of respective occurrences exceeding a predetermined threshold.

27. A combustion boiler system comprising:
a control system that is configured to carry out a method of determining a tube leakage in a water-steam circuit of a combustion boiler system, the method comprising the steps of:
measuring a main steam flow (Q_{MS,M}) prevailing in the water-steam circuit of the combustion boiler system during operation;
modelling the main steam flow (Q_{MS,C}) in the water-steam circuit during operation by utilizing process data in a numerical model of the combustion boiler system giving the main steam (Q_{MS,C}) flow of the combustion boiler system under substantially tube-leak-free conditions;
comparing the measured water-steam flow and the modelled water-steam flow with each other to obtain an error measure (D_{MS}) for main steam flow that is included in an error measure set;
monitoring the error measure set and a number of occurrences in the error measure set during operation; and
determining the presence of a water-steam circuit tube leakage in the case error measures (Δ_{MS}) exceed a pre-defined threshold, or a number of occurrences in the error measure set exceed a predetermined threshold during a predetermined time period.

28. A combustion boiler system, according to claim 27, further comprising a display for displaying to a boiler operator the presence of detected tube leakage detected using the method.
